(19) United States
(12) Patent Application Publication
(10) Pub. No.: US 2004/0145602 A1
(43) Pub. Date: Jul. 29, 2004

(54) Organizing and displaying photographs based on time

(75) Inventors: Yan-Feng Sun, Beijing (CN); Lei Zhang, Beijing (CN); Mingjing Li, Beijing (CN); Hong-Jiang Zhang, Beijing (CN)

Correspondence Address: LEE & HAYES PLLC, 421 W RIVERSIDE AVENUE SUITE 500, SPOKANE, WA, 99201

(73) Assignee: Microsoft Corporation

(21) Appl. No.: 10/351,045

(22) Filed: Jan. 24, 2003

(51) Int. Cl. G09G 5/00

(52) U.S. Cl. 345/720

(57) ABSTRACT

A technique is provided for organizing and displaying digital photographs based on time. The technique includes inputting data representing a photograph and storing the data as a photograph image file. The technique then identifies the manner in which the photograph image file stores time information (such as date and time of day). For instance, the technique determines whether the time information is digitally encoded in the image file, or whether it is embedded within the image data itself. The technique next includes extracting the time information from the photograph image file using a technique appropriate to the identified manner in which the time information is stored, to produce extracted time information. The photographs are then inserted into a time sequence based on the extracted time information, and presented on a calendar display at a location representative of the chronological placement of the photograph within the time sequence.

### TECHNICAL FIELD

This invention relates to a computer technique for managing photograph image files, and in particular, a technique for organizing and displaying photographs based on attribute information associated with the photographs.

### BACKGROUND

Improvements in the processing speed and memory capacity of computers have enabled users to store a relatively large number of photographs in electronic form. For instance, many users scan their photographs using a conventional digital scanner to create scanned digital images of the photographs. The computer saves the scanned images in computer files using a conventional storage format, such as the popular Joint Photographic Experts Group (JPEG) format or Graphical Image Format (GIF). Alternatively, the user can generate a digital photograph using a digital camera. These digital photographs can be directly transferred to the computer via a card reader interface or through a direct camera-to-computer connection (e.g., through the computer's Universal Serial Bus port). Still alternatively, the user can receive digital photographs from others via a computer network, such as the Internet, or download digital photographs from Internet websites.

While current technology has greatly increased the ease at which users can digitize and transfer photographs, it also presents new challenges. For instance, after inputting or receiving the photographs, the user must still perform the task of organizing and archiving the digital photographs. Some users perform this task by grouping photograph image files in different group files corresponding to different respective categories. For instance, a user can allocate a group file for storing a collection of photographs associated with a roll of film or a flash memory card. Alternatively, the user can allocate a group file for storing photographs associated with a particular event, such as a vacation, birthday party, graduation, etc. If a user deems that a photograph belongs to more than one category, the user may opt to redundantly store the photograph in multiple group files. The task of manually organizing and maintaining group files can be intrusive, requiring the user to make judgments regarding the classification of photographs, and then enter a number of commands to store the photographs in the appropriate group files. Accordingly, this manual technique may become increasingly cumbersome as the user's digital photo archive grows.

A user may also have difficulty locating photograph image files stored in the above-identified group file system. To locate a particular desired image file, a user peruses the labels associated with the group files to identify an appropriate collection of photographs. Once the user identifies the appropriate group file, the user browses through individual photographs within that file to identify the desired photograph image file. Again, these activities may become increasingly cumbersome and susceptible to error as the user's archive increases.

Accordingly, there is a need in the art for a more effective technique for managing digital photographs.

### SUMMARY

The technique described in the present specification addresses the above-identified needs in the art.

More specifically, the technique described herein pertains to a method for automatically organizing and displaying photographs based on time. The technique includes inputting data representing a photograph and storing the data as a photograph image file, such as a conventional JPEG file. The technique then includes identifying the manner in which the photograph image file stores time information. This operation can include determining whether the photograph image file includes digitally-encoded time information, such as time information coded in the EXIF format. If the photograph image file does not include digitally-encoded time information, the technique determines whether the photograph image file includes time information embedded in the image data itself, representative of time information printed on the photograph by a film-based camera and scanned by a digital scanner device. And if the photograph image file includes neither digitally-encoded time information nor embedded time information, the technique identifies a time when the photograph image file was created as a proxy for the time when the photograph was taken. Once the time information has been identified, the technique extracts the time information from the photograph image file using a technique appropriate to the identified manner in which the time information was stored, to produce extracted time information.

The technique next includes adding the photograph to a time sequence based on the extracted time information, and then displaying the photograph on a display device at a position representative of the chronological placement of the photograph within the time sequence. More specifically, the step of displaying comprises presenting a depiction of a calendar on the display device, and displaying the photograph on the calendar based on the chronological placement of the photograph within the time sequence.

The automatic organization of digital photographs based on extracted time information reduces the need for a user to manually organize photographs by creating and maintaining multiple group files. Further, the above technique makes it much easier for a user to locate a desired photograph at a later point in time. Additional advantages and features of the technique are described in the ensuing description.

### BRIEF DESCRIPTION OF THE DRAWINGS

The same numbers are used throughout the drawings to reference like features and components.

FIG. 1 shows an overview of an exemplary technique for the time-based display of photographs.

FIG. 2 shows an exemplary photograph image file format containing digitally-encoded time information.

FIG. 3 shows an exemplary photograph including time information printed thereon by a conventional film-based camera.

FIG. 4 shows an exemplary computer environment for implementing the time-based photograph display technique.

FIG. 5 shows an exemplary flowchart illustrating the operation of the time-based photograph display technique.

FIG. 6 shows an exemplary calendar display produced by the time-based photograph display technique.

FIG. 7 shows an exemplary map display produced by the time-based photograph display technique.

### DETAILED DESCRIPTION

Overview

The term “photograph” used in the ensuing discussion refers most often to images captured by either a conventional film-based camera or a digital camera. However, the term “photograph” may encompass images produced by other devices, such as a video camera. In this context, a “photograph” may comprise a single frame extracted from a video sequence, or may comprise multiple successive frames comprising a video vignette. Further, the term “photograph” may encompass a wide variety of computer-generated digital images, including both still “shots” and animated vignettes.

Further, in the context of this patent disclosure, the term “time information” generally pertains to any chronological information, such as the date on which the photograph was taken and/or the time of day when the photograph was taken.

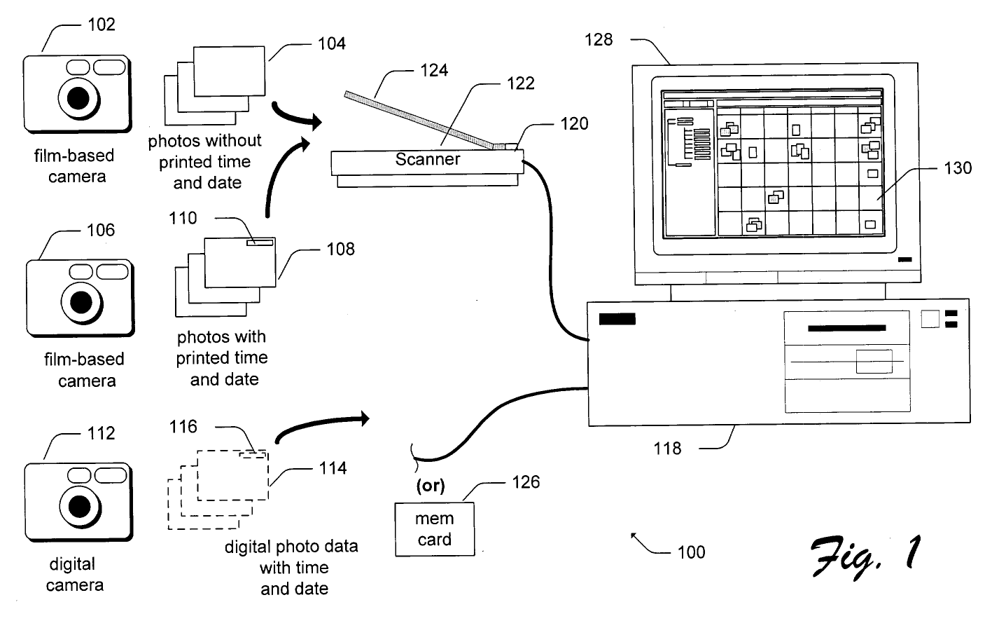

FIG. 1 shows an exemplary system 100 for organizing and displaying photographs based on time information associated with the photographs. The system includes a film-based camera 102 for generating a number of photographs 104 in “hard-copy” (e.g., paper-based) format. These photographs 104 are produced in a conventional manner, for instance, by capturing a series of images on silver halide film, and then developing these images using traditional chemical-based development techniques. The film-based camera 102 specifically generates photographs containing no ancillary data. That is, the photographs are “bare,” containing no supplementary information to identify the conditions under which the photograph was taken.

In contrast, a film-based camera 106 does generate supplementary information. More specifically, this camera 106 generates a collection of photographs 108 including time information 110 printed on the face of the photographs 108 (based on time information formed directly on the film, or later printed on the photographs by film development equipment). The time information 110 conventionally includes the date and time when the photograph was taken, as registered by an internal clock of the camera 106. For instance, camera 106 (or film development equipment) prints the time and date in the corner of the photographs in brightly colored digits (e.g., yellow, red, or green).

The system also includes digital camera 112 which generates a collection of digital images 114. Digital cameras commonly capture a photographic scene using a Charge Coupled Device (CCD) array (not shown) and then store the digital information generated by this array in a memory device, such as a flash memory device (such as the commercially available SmartMedia cards, Memory Sticks, CompactFlash cards, PCMCIA cards, etc.). The camera can store the photographs in different formats, such as the Joint Photographic Experts Group (JPEG) format, Graphical Image Format (GIF), etc.

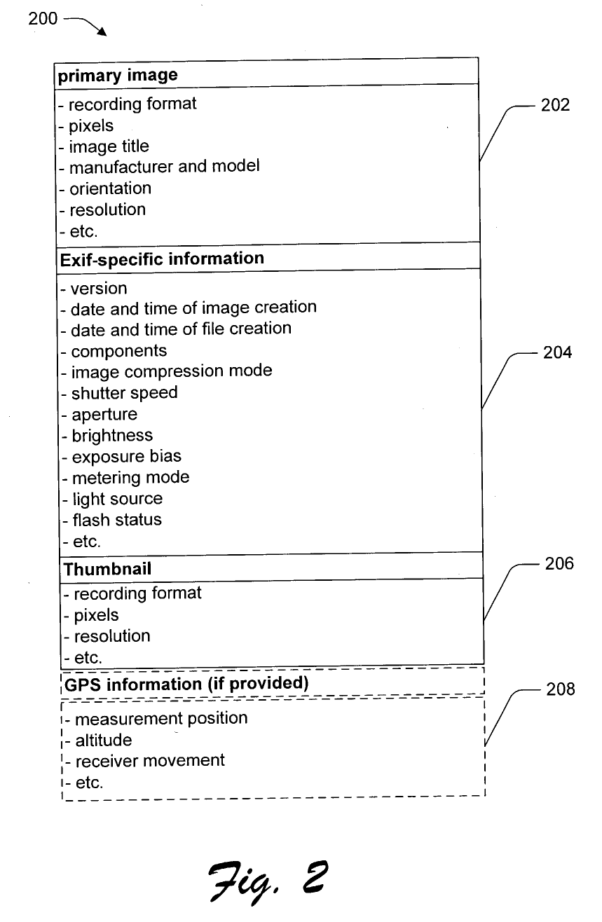

Digital cameras commonly also record a relatively large amount of ancillary data that identifies the conditions under which the photograph was taken. For instance, the digital photos 114 generated by the camera 112 store time information 116. In the EXIF standard, the time information 116 comprises a 20-byte field having the format “YYYY:MM:DD HH:MM:SS,” providing the year (Y), month (M), day (D), hour (H), minute (M), and second (S) when the photo was taken. Additional information regarding the EXIF standard is provided in “Digital Still Camera Image File Format Standard (Exchangeable image file format for Digital Still Cameras: Exif), Version 2.1,” by Japan Electronic Industry Development Association (JEIDA), Jun. 12, 1998. Additional details regarding the exemplary EXIF file format are also provided in the context of FIG. 2 of this disclosure, to be discussed shortly.

Although not shown, the photograph management technique can process photographs produced by other types of cameras besides cameras 102, 106, and 112. For instance, an Advanced Photographic System (APS) camera can be used to generate photographs. This type of camera stores ancillary data on a magnetic strip, including time information. Development equipment reads the ancillary data and uses it in the development process. Accordingly, there exists the possibility that the ancillary information can be extracted and stored separately from the developed photographs.

The system 100 includes a general purpose computer 118 for receiving the photographs. Different strategies can be used to transfer the photographs to the computer 118 depending on the source of the photographs. For instance, the technique uses a conventional scanner 120 to digitize “hard-copy” collections (104, 108) of photographs. Any type of scanner can be used, including, for instance, flatbed type scanners, sheet-feeding batch type digital scanners, etc. Alternatively, a film scanner can be used to directly digitize information obtained from developed film or slides. FIG. 1 shows the exemplary use of a flatbed type of scanner 120. Such a scanner 120 operates by placing a photograph or photographs onto a glass plate 122 of the scanner 120, and closing a scanner cover 124. A stepping motor (not shown) then moves a scan head (not shown) containing a CCD imaging device (not shown) across the photograph in successive passes. The scanner 120 transfers image data collected in the scanning process to computer 118 through an appropriate interface in conventional fashion (e.g., through the serial, parallel, or USB ports of the computer 118, etc.). The computer 118 then processes the image data and creates a photograph image file for storing the data in an appropriate format (such as the JPEG or GIF formats). While this description presumes that the bulk of the image processing tasks are performed by computer 118, the system 100 can allocate some of these tasks to the scanner 120.

In contrast, the collection of digital photographs 114 generated by digital camera 112 is already in a format for direct input into computer 1118. Different techniques are available for performing this transfer. According to one technique, the digital camera 1112 stores the digital photographs on a memory device 126, such as a flash memory device. The computer 1118 can include a memory reading 100 device (not shown) for receiving the memory device 126. Transfer consists of removing the memory device 126 from the digital camera 112, inserting it into the reading device (not shown), and uploading the digital photographs to the memory system (not shown) of the computer 118. Alternatively, many digital cameras allow a user to directly connect the digital camera to the computer 118 via conventional coupling strategies, such as by USB bus, serial port connection, parallel port connection, etc.

Still alternatively, the user can receive a digital photograph via a computer network (not shown) from a remote computing device (not shown). For instance, a friend or family member of the user can send an e-mail to the user, attaching a collection of photographs. Alternatively, a user can download one or more photographs from an Internet website (or an analogous on-line repository of photographs) in a conventional manner. Photographs received via a computer network may have been originally generated in the manner described above, that is, by scanning “hard-copy” versions of the photographs with a scanner, or by

Whatever data transfer path the photograph takes, when the computer 118 receives the photograph, it stores the photograph as a photograph image file, e.g., using the JPEG, GIF, or some other format. The computer 118 then examines the photograph image file to identify the manner in which the photograph image file stores time information. More specifically, this operation includes determining whether the photograph image file includes digitally-encoded time information, such as time information coded in the EXIF format. This would suggest that the photograph originated from the digital camera 112, or through an analogous digital device. If the photograph image file does not include digitally-encoded time information, the technique determines whether the photograph image file includes time information embedded in its image data. This finding would indicate that the source of the digital photograph is the film-based camera 106, which prints time information 110 on the photograph (e.g., in the corner of the photograph). Finally, if the photograph image file includes neither digitally-encoded time information nor printed time information, the technique identifies a time when the photograph image file was created as a proxy for the time when the photograph was taken. This file creation time information may correspond to the time that the photograph image information was received and stored by the computer 118, and will generally not coincide with the time that the photograph was taken. Once the time information has been identified, the technique extracts the time information from the photograph image file using a technique appropriate to the identified manner in which the time information was stored, to produce extracted time information.

The technique next includes inserting the photograph into a time sequence based on the extracted time information, and then displaying the photograph on a display device 128 at a position representative of the chronological placement of the photograph within the time sequence. As shown in FIG. 1, the display device 128 presents a calendar display 130. The photograph is presented on the calendar display 130 based on the chronological placement of the photograph within the time sequence. More specifically, the calendar display 130 includes a series of slots pertaining to days of the month. Photographs that were created on those particular days (as indicated by the extracted time information) are stored within corresponding slots within the calendar.

The automatic presentation of photographs on the calendar display 130 eliminates the need for a user to manually examine the photographs and make a judgment regarding their proper classification. Further, the calendar display 130 also facilitates the later retrieval and browsing of photographs. Additional features and advantages of the disclosed technique are provided below, with reference to FIGS. 2-7.

FIG. 2 shows an exemplary format 200 of a photograph image file created from input data received from digital camera 112. The format 200 shown in FIG. 2 is generally excerpted from information provided in the above-identified JEIDA EXIF standard document. The format 200 includes information 202 pertaining to a primary image, information 204 pertaining to EXIF-specific data, information 206 pertaining to a thumbnail image, and information 208 pertaining to Global Positioning System (GPS) data (if provided by the image capturing camera). It should be noted that format 200 is presented only as an illustration of the type of information that can be presented in a digital image file; various specific commercial implementations may omit certain information discussed below, or may supplement the information described below with additional data. Moreover, the arrangement shown in FIG. 2 does not necessarily reflect a physical grouping of data within a photograph image file.

The primary image information 202 can include an indication of recording format (e.g., JPEG), pixels forming the image (e.g., comprising a 620×475 pixel image), an image title, image input equipment manufacturer, image input equipment model name, orientation (e.g., orientation of the digital camera with respect to the photographed scene), image resolution (e.g., 72 dpi width, 72 dpi length), etc. The EXIF-specific information 204 can include an indication of the version of the standard reflected in the file (e.g., EXIF Ver. 2.1), date and time of original image creation (e.g., “YYYY:MM:DD HH:MM:SS”), date and time of file creation, components (e.g., Y, Cb, Cr), image compression mode (e.g., 2 bit/pel), shutter speed (e.g., 59/10), aperture (e.g., 50/10), brightness level (e.g., 10/10), exposure bias (e.g., 0/0), metering mode (e.g., “multispot), light source (e.g., daylight), flash ON/OFF status, etc. The Thumbnail image information 206 can include information pertaining to the thumbnail rendering of the digital image, including recording format (e.g., JPEG), pixels in the image (e.g., 80×60), image resolution (e.g., 72 dpi width, 72 dpi length), etc. Finally, if GPS information 208 is provided by the camera, it can include measurement position information, altitude information, an indication of GPS receiver movement (e.g., an indication that the receiver is moving at 1 km/h), etc. Again, the tags identified above are exemplary, and are presented to give the reader an exemplary sampling of the type of information that can be stored in digital photograph image files. The above-identified EXIF standard document provides additional information pertaining to the above-identified fields, as well as additional fields that can be included in a file formatted according the EXIF format.

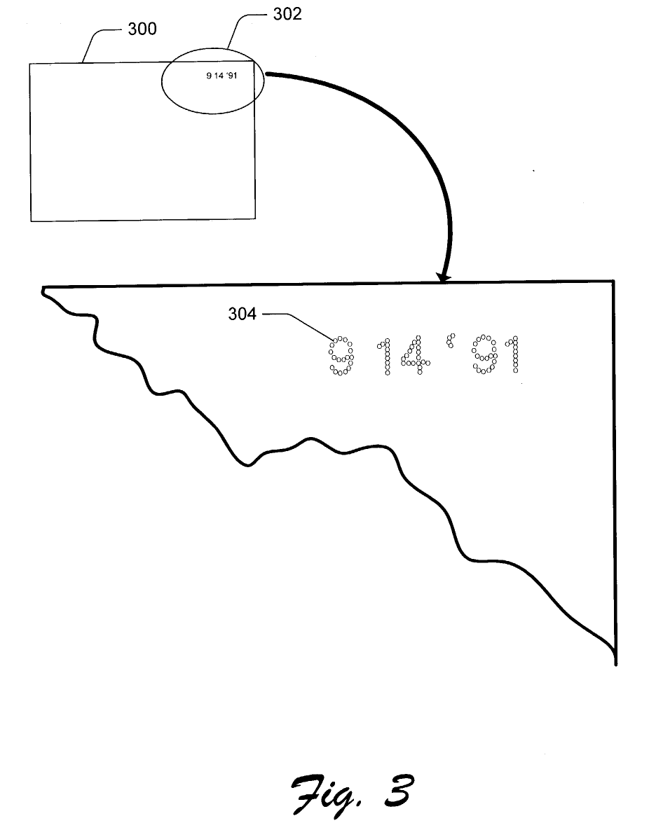

FIG. 3 shows a “hard-copy” photograph 300 produced by camera 106 (shown in FIG. 1). This photograph 300 includes time information 302 printed on its face. The lower portion of FIG. 3 shows an enlarged view of the time information 302. As shown there, the camera 106 has formed the time information 302 through a series of small dots 304 (e.g., to create the date “9 14 '91, representing Sep. 14, 1991). These dots 304 typically have a bright color, such as bright yellow, red or green so as to stand out against the background image. Other cameras may form the date using a series of illuminated line segments (not shown), or using other digit-formation techniques. The appearance of time information printed on the face of the photograph may change slightly depending on the underlying image. If the background is dark, the time information may appear to dilate slightly.

Exemplary Computing Environment

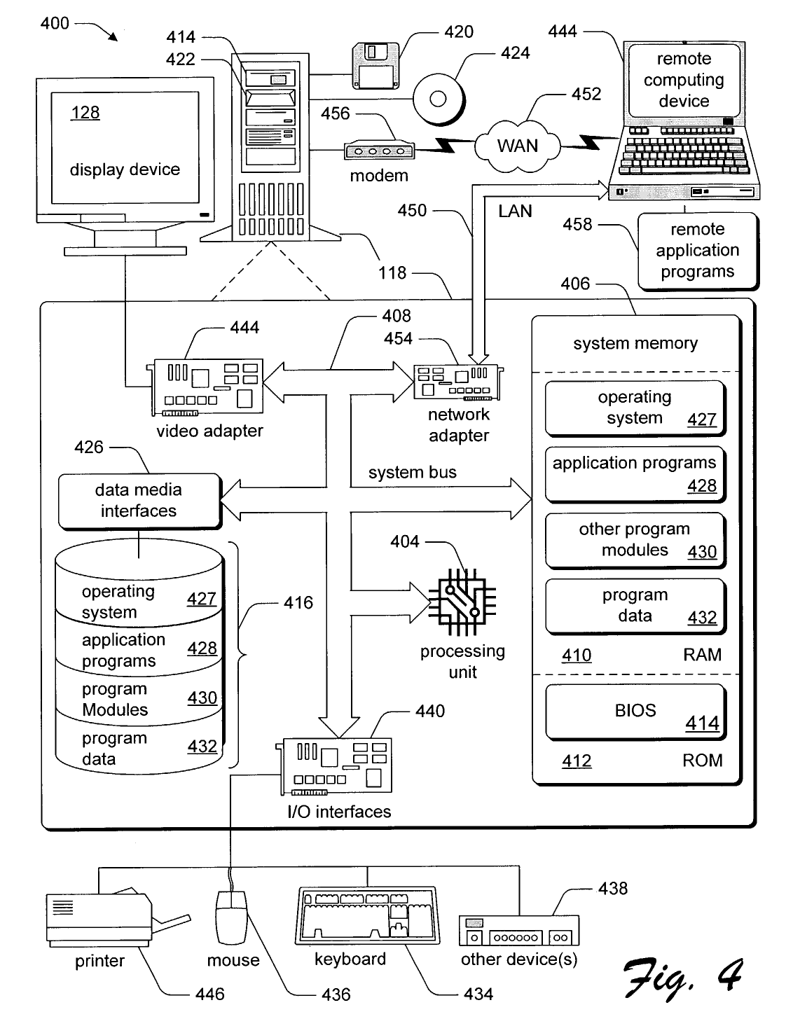

FIG. 4 illustrates one example of a computing environment 400 within which the above-described photograph management technique can be either fully or partially implemented. The computing environment 400 includes the general purpose computer 118 and display device 128 discussed in the context of FIG. 1. However, the computing environment 400 can include other kinds of computer and network architectures. For example, although not shown, the computer environment 400 can include hand-held or laptop devices, set top boxes, programmable consumer electronics, mainframe computers, gaming consoles, etc. Further, FIG. 4 shows elements of the computer environment 400 grouped together to facilitate discussion. However, the computing environment 400 can employ a distributed processing configuration. In a distributed computing environment, computing resources can be physically dispersed throughout the environment.

Exemplary computer 118 includes one or more processors or processing units 404, a system memory 406, and a bus 408. The bus 408 connects various system components together. For instance, the bus 408 connects the processor 404 to the system memory 406. The bus 408 can be implemented using any kind of bus structure or combination of bus structures, including a memory bus or memory controller, a peripheral bus, an accelerated graphics port, and a processor or local bus using any of a variety of bus architectures. For example, such architectures can include an Industry Standard Architecture (ISA) bus, a Micro Channel if Architecture (MCA) bus, an Enhanced ISA (EISA) bus, a Video Electronics Standards Association (VESA) local bus, and a Peripheral Component Interconnects (PCI) bus also known as a Mezzanine bus.

Computer 118 can also include a variety of computer readable media, is including a variety of types of volatile and non-volatile media, each of which can be removable or non-removable. For example, system memory 406 includes computer readable media in the form of volatile memory, such as random access memory (RAM) 410, and non-volatile memory, such as read only memory (ROM) 412. ROM 412 includes an input/output system (BIOS) 414 that contains the basic routines that help to transfer information between elements within computer 118, such as during start-up. RAM 410 typically contains data and/or program modules in a form that can be quickly accessed by processing unit 404.

Other kinds of computer storage media include a hard disk drive (not shown) for reading from and writing to a non-removable, non-volatile magnetic media 416, a magnetic disk drive 414 for reading from and writing to a removable, non-volatile magnetic disk 420 (e.g., a “floppy disk”), and an optical disk drive 422 for reading from and/or writing to a removable, non-volatile optical disk 424 such as a CD-ROM, DVD-ROM, or other optical media. The hard disk drive, magnetic disk drive 414, and optical disk drive 422 are each connected to the system bus 404 by one or more data media interfaces 426. Alternatively, the hard disk drive, magnetic disk drive 414, and optical disk drive 422 can be connected to the system bus 404 by a SCSI interface (not shown), or other coupling mechanism. Although not shown, the computer 118 can include other types of computer readable media, such as magnetic cassettes or other magnetic storage devices, flash memory cards, CD-ROM, digital versatile disks (DVD) or other optical storage, electrically erasable programmable read-only memory (EEPROM), etc. For instance, as discussed above, many digital cameras store digital photographs on portable memory devices, such as flash memory devices. The computer 118 can accordingly include a card reader (not shown) to receive this memory device.

Generally, the above-identified computer readable media provide non-volatile storage of computer readable instructions, data structures, program modules, and other data for use by computer 118. For instance, the readable media can store an operating system 427, one or more application programs 428, other program modules 430, and program data 432.

The computer environment 400 can include a variety of input devices. For instance, the computer environment 400 includes a keyboard 434 and a pointing device 436 (e.g., a “mouse”) for entering commands and information into computer 118. The computer environment 400 can include other input devices 438 (not specifically illustrated), such as a microphone, joystick, game pad, satellite dish, serial port, scanner, card reading devices, digital or video camera, etc. Input/output interfaces 440 couple the input devices to the processing unit 404. More generally, input devices can be coupled to the computer 118 through any kind of interface and bus structures, such as a parallel port, serial port, game port, universal serial bus (USB) port, etc.

The computer environment 400 also includes the display device 128, generally corresponding to the display device 128 shown in FIG. 1. A video adapter 444 couples the display device 128 to the bus 408. In addition to the display device 128, the computer environment 400 can include other output peripheral devices, such as speakers (not shown), a printer 446, etc. I/O interfaces 440 can be used to couple these other output devices to the computer 118.

Computer 118 can operate in a networked environment using logical connections to one or more remote computers, such as a remote computing device 444. The remote computing device 444 can comprise any kind of computer equipment, including a general purpose personal computer, portable computer, a server, a router, a network computer, a peer device or other common network node, etc. Remote computing device 444 can include all of the features discussed above with respect to computer 118, or some subset thereof.

Any type of network can be used to couple the computer 118 with remote computing device 444, such as a local area network (LAN) 450, or a wide area network (WAN) 452 (such as the Internet). When implemented in a LAN networking environment, the computer 118 connects to local network 450 via a network interface or adapter 454. When implemented in a WAN networking environment, the computer 118 can connect to the WAN 452 via a modem 456 or other connection strategy. The modem 456 can be located internal or external to computer 118, and can be connected to the bus 408 via the I/O interfaces 440 or other appropriate coupling mechanism. Although not illustrated, the computing environment 400 can provide wireless communication functionality for connecting computer 118 with remote computing device 444 (e.g., via modulated radio signals, modulated infrared signals, etc.).

In a networked environment, the computer 118 can draw from program modules stored in a remote memory storage device 458. Generally, the depiction of program modules as discrete blocks in FIG. 4 serves only to facilitate discussion; in actuality, the programs modules can be distributed over the computing environment 400, and this distribution can change in a dynamic fashion as the modules are executed by the processing unit 404.

Wherever physically stored, one or more of the application programs 428 shown in FIG. 4 can be provided to implement the photograph management techniques described above. The application program for managing photographs can include (or may be conceptualized to include) various modules for performing principal tasks within with the technique. For instance, the application program can provide input logic for inputting data representing a photograph and for storing the data as a photograph image file (e.g., in RAM 412 and/or hard disk 416, etc.). The application program can provide identification logic for identifying a manner in which the photograph image file stores time information. The application program can provide extraction logic for extracting the time information from the photograph image file using a technique appropriate to the identified manner in which the time information is stored, to produce extracted time information. The application program can include sorting logic configured to add the photograph to a time sequence based on the extracted time information. The application program can also include interface logic configured to display the photograph on the display device 128 at a position indicative of the chronological placement of the photograph within the time sequence, such as within the context of a calendar-type display. Other program modules can be used to implement additional functionality provided by the photograph management technique, although not specifically identified here.

Method and Associated User Interface Features

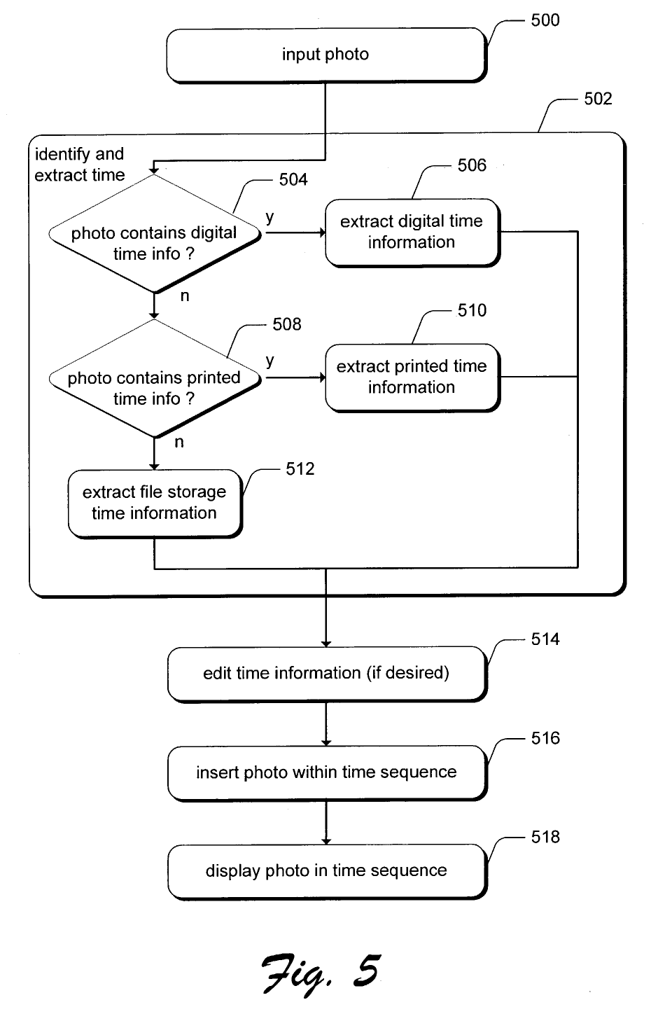

FIG. 5 shows an exemplary method for displaying photos in a time sequence in flowchart form. The computer 118 begins by inputting a photograph in step 500. (To simplify the discussion, FIG. 5 pertains to the input and processing of a single photograph. However, the method shown in FIG. 5 can be used to input and process an entire batch of photographs.) As described above in connection with FIG. 1, the computer 118 can perform the inputting step by receiving digital photograph data supplied by a digital scanning device 120. The digital scanner 120 scans a “hard-copy” rendering of the photograph. This photograph may or may not include printed time information formed on its face. Alternatively, the input step 500 can comprise reading a memory device 126 containing digital photographs stored by digital camera 112, or receiving digital photographs directly from the digital camera 112 via cable, or by some other transfer technique. Still alternatively, input step 500 can comprise receiving digital photographs via a network connection, e.g., by receiving an e-mail over the network connection containing an attached digital photograph. In any case, the computer 118 stores the digital photograph in memory, creating, in the terminology of this patent disclosure, a photograph image file. More specifically, the creation of the image file can involve specifically formatting the image data into a desired format, such as a JPEG format, or can simply involve transferring a previously formatted file (e.g., created by the digital camera or other digital device) to the computer's memory.

In step 502, the computer 118 identifies time information within the photograph image file and extracts this information. This step includes several substeps. In step 504, the computer 118 determines whether the photograph includes digitally-encoded time information, indicating that it was created by a digital camera or analogous device. If so, in step 506 the computer 118 extracts this information. More specifically, the time information is stored in a predefined and predictable format in accordance with the standard used in the file's creation. Accordingly, the computer 118 is configured to determine the format used by the photograph image file, determine how this format stores the time information, and then extract the time information based on these determinations. To provide a versatile extraction mechanism, the computer 118 can include several different modules designed to process photograph images having different formats.

If the image file does not contain digitally-encoded time information, the computer 118 next determines, in step 508, whether its image data includes data indicative of time information. That is, the photograph may have originally included time information printed on its corner. Upon scanning the photograph, this time information is captured as simply another part of the image itself, and in this sense is “embedded” in the image. The computer 118 can determine whether the image data within the photograph image file contains time information by performing image analysis on one or more peripheral locations within the photograph corresponding to the regions of the photograph where time information is likely to be printed. This step can involve examining these image regions to determine whether they contain characteristic patterns and/or colors used in printed date information. If the computer 118 determines that the regions include such information, it then advances to step 510, at which time it performs a full analysis of the printed time information to determine and extract the time information. In an alternative embodiment, the technique can merge steps 508 and into a single image analysis operation.

Generally, a variety of image analysis techniques can be used to detect and extract the printed time information embedded in the image data. For instance, optical character recognition (OCR) can be used to detect and/or extract the time information. Alternatively, more sophisticated techniques can be used.

For example, a two-stage Bayesian skeleton template-matching algorithm can be used to detect and recognize time information embedded in a scanned photograph. In the first part, the algorithm uses Bayesian skeleton template-matching to determine the digits having the highest probability of being present in the time information. This part of the algorithm is performed by executing Bayesian analysis on a digit by digit basis. More specifically, for each digit, small patches are processed using a Bayesian framework, “comparing” the small patches with respect to a series of skeleton templates corresponding to the normal (i.e., expected) appearance of digits within the time information.

In the second part, the algorithm again uses Bayesian skeleton matching to identify the most likely content of the time information field considered as a whole. For instance, different cameras store time information in different formats. One camera may store the date as Year-Month-Day, while another may store it as Month-Day-Year, etc. Further, the distances between different parts of the time information may differ from camera to camera. Accordingly, in the second part of the algorithm, the computer determines the most suitable template by performing Bayesian analysis with respect to all of the potential formats. In performing this analysis, the second part of the algorithm factors in the results of the first part, for example, by calculating a weighted average of the probabilities of the individual digits within the time information (this weighted average representing the state-conditional probability density function for a given image patch).

Performing the above-identified analysis over a large portion of the photograph image may require a substantial amount of processing time. Accordingly, several heuristic rules can be applied to reduce the search space.

A first rule posits that the size of the time information field is likely to be proportional to the size of the entire photo. This rule can be used to select template sizes that most likely match the size of the time information field, thus reducing the number of templates considered in the Bayesian analysis.

A second rule posits that most cameras print the time information in an upper corner of the photograph, or some other peripheral region. This rule can be used to reduce the amount of the image that is subjected to image analysis.

A third rule posits that there are certain impossibilities and improbabilities in the entire universe of time information permutations. For example, the month field cannot exceed 12. Further, the time information is unlikely to identify a date prior to 1980, because the technology for printing dates on photographs was not prevalent before that time. Knowledge of these impossibilities and improbabilities can be used to restrict the number of date permutations that need to be considered by the image analysis.

A fourth rule posits that, when a user scans a batch of photographs, it is likely that all of the photographs share the same time information format. Further, the time information in successive photographs may represent an ordered chronological sequence (as when the user is scanning a series of pictures taken in a single role of film). Again, this rule can be used to reduce the amount of analysis performed by the algorithm, for instance, by more quickly homing in on a likely range of time information permutations.

Returning to the steps in FIG. 5, if the decision in step 508 is answered in the negative, this means that the photograph image file likely does not contain any information indicating when the photograph was taken. If this is the case, the computer 118 advances to step 512, where the computer 118 extracts information from the photograph image file indicative of when the file was created. For instance, the file creation time may correspond to the time when the photograph was scanned by the scanner 120 and input into the computer 118. This information does not correspond to the time when the photograph was created, but at least may serve as a rough proxy for the “age” of the photograph.

In step 514, the computer 118 allows the user to correct the time information extracted in step 502. For instance, the digital camera 112 may have incorrectly registered the time information because its internal clock was set incorrectly. Alternatively, the image analysis may have incorrectly recognized the date information. Finally, as explained above, the time information identified in step 512 (representative of the file creation time) is a priori incorrect. Accordingly, step 514 allows the user to manually change and store the correct time information based on the user's independent assessment of the correct time information. Although not shown, this step can take the form of a graphical display interface which displays the time information extracted in step 502, and then prompts the user to correct the time information through the graphical user interface.

In step 516, the computer 118 inserts the input photograph within a time sequence. For instance, the computer 118 can store an archive containing multiple photographs. The computer 118 determines the “placement” of the new photograph (or collection of new photographs) with respect to the previously input photographs. This can be performed by sorting all of the photographs with respect to the time information field. Sorting can be performed using any one of several traditional methods, e.g., by manipulating an array of record pointers.

Finally, in step 518, the computer 118 displays the photograph on the display device 128 at a position indicative of the chronological placement of the photograph within the time sequence, such as by displaying the photograph on a calendar display at a location representative of the day and/or time on which it was taken. In one implementation, the computer 118 can perform step 516 (e.g., inserting the photograph into a time sequence) in advance of a request by the user to display the photograph on a calendar display. In another implementation, the computer 118 performs step 516 only when the user makes a request to display the photograph. In the latter implementation, the computer 118 need not actually store a sorted file of image file records; in this case, the computer 118 orders the photographs using the time information field each time a calendar display page is received. Still other variations are possible for ordering a collection of photographs by time.

To facilitate discussion, the steps in FIG. 5 were discussed in the context of processing performed by computer 118 shown in FIGS. 1 and 4. However, one or more of the processing steps can be allocated to other devices, such the scanning device 120. For instance, the scanning device 120 can be configured to include and execute code for identifying and extracting time information stored in the scanned photograph; in this case, the image data that is transferred to computer 118 can include a digitally-encoded time information field representative of the time information extracted from the photograph by scanner 120.

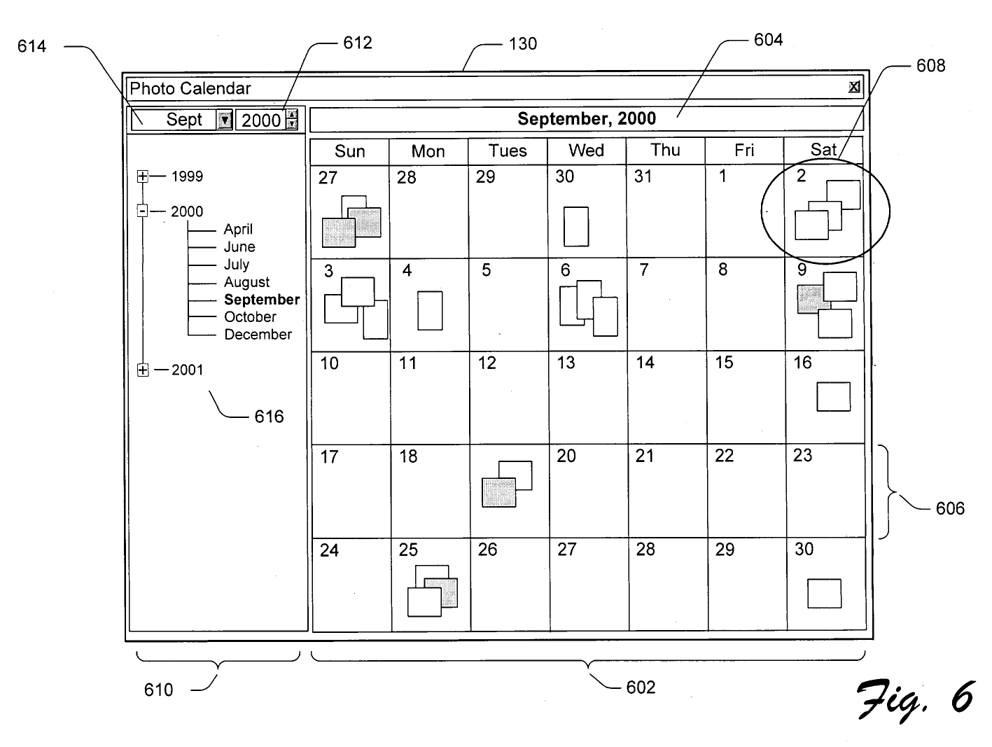

FIG. 6 shows an exemplary calendar display 130 for displaying photographs in a time sequence. The display includes two main fields. A first calendar field 602 presents a calendar page 604 corresponding to a month of the year. The first field 602 has a calendar lay-out, showing different slots 606 associated with different days, each row in the calendar pertaining to a different week of the 11 month. Photographs are displayed in the slots corresponding to the days in which the photographs were taken. For instance, three photographs 608 were taken on Saturday, Sep. 2, 2000. Accordingly, these photographs are displayed within the slot on the calendar corresponding to Sep. 2, 2000. Although not particularly illustrated in FIG. 6, the photographs are preferably represented in the calendar display 130 by thumbnail images of the photographs. This thumbnail information represents a reduced-size replica of the image, and is commonly stored in JPEG-type files, as well as other types of image files.

In an alternative embodiment, the photographs displayed for a particular day comprise a representative sample of the photographs taken on that day. To determine the representative sample, the computer 118 can perform clustering analysis to determine similarities within the photographs taken on a particular day. In assessing similarity, the computer 118 can examine the clustering of the photographs with respect to time, as well as the similarity in the photographs' image content (e.g., by performing conventional scene-based image analysis on the photographs). If the collection of photographs taken on a particular day can be divided into such groupings, the computer 118 can select and display one representative photograph from each grouping.

For example, a user may have taken several photographs on Sep. 2, 2000 while on vacation in a particular city. As might be expected, the user may thus have taken a series of photographs at each of a selected number of landmarks within the city, such as a collection of photographs taken at the city's zoo, a collection of photographs taken at the city's museums, etc. Each grouping of photos is thus likely to represent a distinct clustering of similar image capture times and possibly similar image content information. Representative photographs can be taken from each of these groupings. In yet another implementation, the computer can cluster the photographs based on face recognition, and select representative photos within a particular day for each of the people that the user has taken a picture of.

A second field 610 in the display 130 shows a selection mechanism for changing the month shown in the first field 602. More specifically, the user can select a desired year and month through selection menus 612 and 614. Selection menu 612 can be scrolled up and down to select a particular year. Selection menu 614 includes a drop-down menu for selecting the desired month. The computer 118 responds to the selected year and month by changing the calendar month page 604 shown in the first display field 602.

Alternatively, the user can select a desired year and month through selection tree 616. Selection tree 616 comprises a hierarchical tree showing a number of years. Pointing to and clicking on a particular year causes the year field to open up to display the months within the year for which the user has previously taken photographs. In an alternative implementation, the computer 118 can display all of the months of the year, regardless of whether the user has taken photographs within certain months.

Different variations on the calendar display motif are possible. For instance, the first portion 602 can display a larger segment of time than one month, such as a three-month period, or an entire year. Alternatively, the first portion 602 of the display 130 can present a smaller segment of time, such as a week, or even a day (or even a portion of a day). In the case of the display of only a day, the first portion 602 can be divided into segments corresponding to hours within the day, and the photographs can be arranged within those segments corresponding to the times at which they were taken. In yet another implementation, the calendar display 130 can allow the user to switch from the month display to a week display or day display by clicking on a particular week or day within the month display, etc.

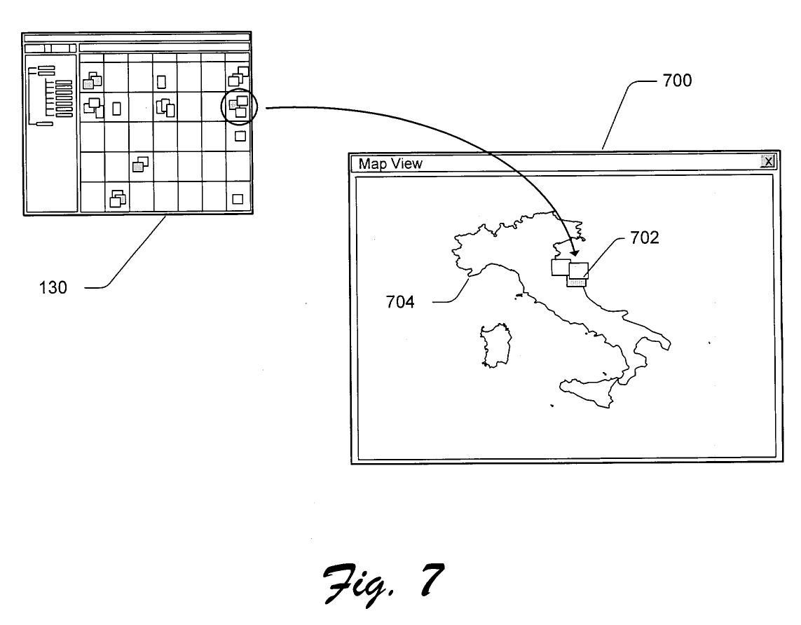

In yet another implementation, the computer 118 can be configured in such a manner that clicking on a particular day (or other time slot in the calendar display 130) will activate a map-type display. FIG. 7 illustrates an exemplary implementation of this feature. As indicated there, the user has clicked on Sep. 9, 2000, prompting the computer 118 to generate a map display 700 which indicates the locations where the photographs captured on that particular day were taken. As seen in FIG. 7, three photographs 702 were taken on Sep. 9, 2000, in Venice, Italy. Accordingly, the computer 118 displays the three photographs on a map 704 of Italy corresponding to the location of Venice, Italy. Although not shown, the computer 118 can be further configured to drill down to provide a more detailed map of the city, showing the precise locations where the photographs were taken. Further, although not shown, the map display 700 can include a selection tree menu analogous to the tree 616 shown in FIG. 6, but in this case showing a variety of locations within a particular country or city. For instance, root nodes on the selection tree can correspond to different countries, and leaf nodes in the selection tree can correspond to cities within the countries where photographs were taken. A yet further breakdown in the tree can show individual locations within the cities.

The map display 700 can determine the locations where the photographs were taken by extracting GPS information from the photograph information files, if available. This information can be extracted along with the time information according to the procedure shown in FIG. 5.

### CONCLUSION

Although the systems and methods have been described in language specific to structural features and/or procedures, it is to be understood that the invention defined in the appended claims is not necessarily limited to the specific features or procedures described. Rather, the specific features and procedures are disclosed as exemplary forms of implementing the claimed invention.

We claim:

1. In a computer system including a display device, a method for displaying photographs based on time, comprising:
inputting data representing a photograph and storing the data as a photograph image file;
identifying a manner in which the photograph image file stores time information;
extracting the time information from the photograph image file using a technique appropriate to the identified manner in which the time information is stored, to produce extracted time information;
adding the photograph to a time sequence based on the extracted time information; and
displaying the photograph on the display device at a position representative of the chronological placement of the photograph within the time sequence.

2. A method according to claim 1, wherein the displaying comprises presenting a depiction of a calendar on the display device, and displaying the photograph on the calendar based on the chronological placement of the photograph within the time sequence.

3. A method according to claim 2, wherein the calendar includes multiple time slots, and the displaying comprises displaying the photograph within a time slot associated with the extracted time information.

4. A method according to claim 1, further comprising displaying the photograph on a map at a position corresponding to a geographic location where the photograph was taken.

5. A method according to claim 1, wherein the identifying comprises determining whether the photograph image file includes digitally-encoded time information, and the extracting includes extracting the digitally-encoded time information.

6. A method according to claim 5, wherein the digitally-encoded time information comprises information recorded according to an EXIF standard.

7. A method according to claim 1, wherein the identifying comprises determining whether the photograph image file includes time information embedded in image data, and the extracting includes extracting the embedded time information.

8. A method according to claim 1, wherein the identifying comprises determining whether the photograph image file fails to include information representative of a time when the photograph was taken, and the extracting includes extracting time information indicative of when the photograph image file was created as a proxy for the time when the photograph was taken.

9. A method according to claim 1, wherein the identifying includes:
determining whether the photograph image file includes digitally-encoded time information;
if the photograph image file does not include digitally-encoded time information, determining whether the photograph image file includes time information embedded in image data; and
if the photograph image file includes neither digitally-encoded time information nor embedded time information, identifying a time when the photograph image file was created as a proxy for the time when the photograph was taken.

10. A computer-readable medium having computer-executable instructions for performing the method recited of claim 1.

11. In a computer system having a graphical user interface including a display device, a method for organizing and displaying photographs based on time, comprising:
inputting data representing a photograph and storing the data as a photograph image file;
identifying a manner in which the photograph image file stores time information, the identifying including:
determining whether the photograph image file includes digitally-encoded time information;
if the photograph image file does not include digitally-encoded time information, determining whether the photograph image file includes time information embedded in image data; and
if the photograph image file includes neither digitally-encoded time information nor embedded time information, identifying a time when the photograph image file was created as a proxy for the time when the photograph was taken;
extracting the time information from the photograph image file using a technique appropriate to the identified manner in which the time information is stored, to produce extracted time information;
adding the photograph to a time sequence based on the extracted time information; and
displaying a depiction of a calendar on the display, and displaying the photograph on the calendar at a position representative of the chronological placement of the photograph within the time sequence.

12. In a computer system having a graphical user interface including a display device and a user interface selection device, a method for displaying photographs based on time, comprising:
displaying a selection interface field on the display device which allows a user to select one of a plurality of calendar pages, each calendar page associated with a segment of time within a time sequence;
receiving a selection from a user via the selection interface field and the interface selection device that specifies one of a plurality of calendar pages;
displaying the specified calendar page on the display device in response to the user's selection;
accessing time information associated with a photograph; and
displaying the photograph on the specified calendar page at a position representative of the time information.

13. A method according to claim 12, wherein the calendar page is associated with a selected month of a selected year.

14. A method according to claim 12, wherein the calendar page includes multiple time slots, and the displaying of the photograph comprises displaying the photograph within a time slot associated with the time information.

15. A method according to claim 14, further including:
receiving a selection from a user via the interface selection device that specifies one of the multiple time slots; and
displaying the photographs contained within the selected time slot on a map at respective positions corresponding to the geographic locations where the photographs were taken.

16. A system for displaying photographs based on time, comprising:
input logic configured to input data representing a photograph and store the data as a photograph image file;
identification logic configured to identify a manner in which the photograph image file stores time information;
extraction logic configured to extract the time information from the photograph image file using a technique appropriate to the identified manner in which the time information is stored, to produce extracted time information;
sorting logic configured to add the photograph to a time sequence based on the extracted time information; and
interface logic configured to display the photograph on a display device at a position representative of the chronological placement of the photograph within the time sequence.

17. A system according to claim 16, wherein the interface logic is configured to present a depiction of a calendar on the display device, and to display the photograph on the calendar based on the chronological placement of the photograph within the time sequence.

18. A system according to claim 17, wherein the calendar includes multiple time slots, and the interface logic is configured to display the photograph within a time slot associated with the extracted time information.

19. A system according to claim 16, further comprising map display logic configured to display the photograph on a map at a position corresponding to a geographic location where the photograph was taken.

20. A system according to claim 16, wherein the identification logic is configured to determine whether the photograph image file includes digitally-encoded time information, and the extraction logic is configured to extract the digitally-encoded time information.

21. A system according to clam 20, wherein the digitally-encoded time information comprises information recorded according to an EXIF standard.

22. A system according to claim 16, wherein the identification logic is configured to determine whether the photograph image file includes time information embedded in image data, and the extraction logic is configured to extract the embedded time information.

23. A system according to claim 16, wherein the identification logic is configured to determine whether the photograph image file fails to include information representative of a time when the photograph was taken, and the extraction logic is configured to extract time information indicative of when the photograph image file was created as a proxy for the time when the photograph was taken.

24. A system according to claim 16, wherein the identification logic is further configured to:
determine whether the photograph image file includes digitally-encoded time information;
if the photograph image file does not include digitally-encoded time information, determine whether the photograph image file includes time information embedded in image data; and
if the photograph image file includes neither digitally-encoded time information nor embedded time information, identify a time when the photograph image file was created as a proxy for the time when the photograph was taken.

25. A system for displaying photographs based on time, comprising:
a computer processing device including:
a data input interface for receiving data;
input logic configured to input data via the data input interface representing a photograph and to store the data as a photograph image file;
identification logic configured to identify a manner in which the photograph image file stores time information by:
determining whether the photograph image file includes digitally-encoded time information;
if the photograph image file does not include digitally-encoded time information, determining whether the photograph image file includes time information embedded in image data; and
if the photograph image file includes neither digitally-encoded time information nor embedded time information, identifying a time when the photograph image file was created as a proxy for the time when the photograph was taken;
extraction logic configured to extract the time information from the photograph image file using a technique appropriate to the identified manner in which the time information is stored, to produce extracted time information;
sorting logic configured to add the photograph to a time sequence based on the extracted time information; and
interface logic configured to output a visual rendering of the photograph at a position representative of the chronological placement of the photograph within the time sequence; and
a display device coupled to the, interface logic for presenting the visual rendering, including:
a calendar display field for presenting a depiction of a calendar page, the calendar page including multiple time slots, wherein the photograph is displayed within a time slot associated with the extracted time information; and
a selection display field for presenting a selection mechanism which allows a user to select one of a plurality of calendar pages.

26. A system for displaying photographs based of time, comprising:
a display device;
a user interface selection device;
selection field display logic configured to display a selection interface field on the display device which allows a user to select one of a plurality of calendar pages, each calendar page associated with a segment of time within a time sequence;
receiving logic configured to receive a selection from a user via the selection interface field and the interface selection device that specifies one of a plurality of calendar pages;
calendar display logic configured to display the specified calendar page on the display device in response to the user's selection;
access logic configured to access time information associated with a photograph; and
photograph display logic configured to display the photograph on the specified calendar page at a position representative of the time information.

27. A system according to claim 26, wherein the calendar page is associated with a selected month of a selected year.

28. A system according to claim 26, wherein the calendar page includes multiple time slots, and the photograph display logic comprises logic configured to display the photograph within a time slot associated with the time information.

29. A system according to claim 28, further including:
time slot selection logic configured to receive a selection from a user via the interface selection device that specifies one of the multiple time slots; and
map display logic configured to display the photographs contained within the selected time slot on a map at respective positions corresponding to the geographic locations where the photographs were taken

30. A display device for displaying photographs in a time sequence, comprising:
a calendar display field for presenting a depiction of a calendar page, the calendar page including multiple time slots; and
a selection display field for presenting a selection mechanism which allows a user to select one of a plurality of calendar pages,
wherein each photograph includes a photograph image file associated therewith, and wherein the photographs are arranged within the time slots of a calendar page based on time information contained in their respective photograph image files.
